(19) United States
(12) Patent Application Publication
(10) Pub. No.: US 2006/0123211 A1
(43) Pub. Date: Jun. 8, 2006

(54) Method for optimizing a snapshot operation on a file basis

(75) Inventors: David G. Derk, Gibsonia, PA (US); Robert C. Edwards JR., Susquehanna, PA (US); Omar B. Vargas, Port Orange, FL (US)

Correspondence Address: CARDINAL LAW GROUP, 1603 ORRINGTON AVENUE, SUITE 2000, EVANSTON, IL, 60201, US

(73) Assignee: International Business Machines Corporation, Armonk, NY (US)

(21) Appl. No.: 11/007,528

(22) Filed: Dec. 8, 2004

(51) Int. Cl. G06F 12/16

(52) U.S. Cl. 711/162

(57) ABSTRACT

To implement snapshot operations of a storage volume, a snapshot agent is invoked to initiate the snapshot operations of the storage volume, to establish access to a directory of one or more files to be excluded from the snapshot operations of the storage volume, and to process each write request of the storage volume based on the directory of file(s) to be excluded from the snapshot operations of the storage volume. The storage agent can additionally process each read request of the storage volume based on the directory of file(s) to be excluded from the snapshot operations of the storage volume.

### FIELD OF INVENTION

The present invention generally relates to a snapshot processing of a storage volume that facilitates updates and reads of the storage volume. The present invention specifically relates to optimizing each snapshot operation (e.g., copy-on-write operation and a cache-write operation) of the storage volume on a file basis.

### BACKGROUND OF THE INVENTION

To allow for the recovery of data in the event of a failure of a storage volume or its associated computer system(s), a backup copy of the data is periodically made to a backup volume during the operation of the computer system(s) by a reading of the data from the storage volume and a writing of the read data to a backup volume. However, since the data is being backed up while the computer system(s) are still in operation, the read data as written to the backup volume may be inconsistent with the storage volume if any update to the read data by other programs occurs in the storage volume during the backup of the storage volume. One solution to this problem is a launching of a snapshot agent during the backup operation to facilitate a generation and management of a point-in-time copy of the storage volume that maintains consistency between the backup volume and the storage volume at the launching time of the snapshot agent. A challenge for the computer industry is to ensure the snapshot agent does not negatively impact system performance during the snapshot processing of updates and read of the storage volume.

### SUMMARY OF THE INVENTION

The present invention provides a new and unique method of snapshot processing of updates and reads of a storage volume on a file basis.

One form of the present invention is a signal bearing medium tangibly embodying a program of machine-readable instructions executable by one or more processor(s) to perform operations for (1) initiating snapshot operations of the storage volume; (2) establishing access to a directory of at least one file to be excluded from the snapshot operations of the storage volume; and (3) processing a write request associated with the storage volume based on the directory of at least one file to be excluded from the snapshot operations of the storage volume.

A second form of the present invention is a system employing one or more processors, and one or more memories for executing instructions for (1) initiating snapshot operations of the storage volume; (2) establishing access to a directory of at least one file to be excluded from the snapshot operations of the storage volume; and (3) processing a write request associated with the storage volume based on the directory of at least one file to be excluded from the snapshot operations of the storage volume.

A third form of the present invention is a system employing (1) means for initiating snapshot operations of the storage volume; (2) means for establishing access to a directory of at least one file to be excluded from the snapshot operations of the storage volume; and (3) means for processing a write request associated with the storage volume based on the directory of at least one file to be excluded from the snapshot operations of the storage volume.

A fourth form of the present invention is a client computer employing a backup module and a snapshot agent. The backup module and the snapshot agent include means for implementing integrated backup/snapshot operations of a storage volume based on a directory of at least one file to be excluded from the integrated backup/snapshot operations of the storage volume.

The forgoing forms and other forms, objects, and aspects as well as features and advantages of the present invention will become further apparent from the following detailed description of the various embodiments of the present invention, read in conjunction with the accompanying drawings. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates an exemplary operational environment for an integration of a backup module and a snapshot module in accordance with the present invention;

FIG. 2 illustrates a flowchart representative of a storage volume access method in accordance with the present invention, and a flowchart representative of a snapshot processing method in accordance with the present invention;

FIG. 3 illustrates an exemplary generation of an exclude extent list directory;

FIG. 4 illustrates a flowchart representative of one embodiment of a copy-on-write processing method of write requests in accordance with the present invention;

FIG. 5 illustrates an exemplary execution of the flowchart illustrated in FIG. 4;

FIG. 6 illustrates a flowchart representative of one embodiment of copy-on-write processing method of read requests in accordance with the present invention;

FIG. 7 illustrates an exemplary execution of the flowchart illustrated in FIG. 6;

FIG. 8 illustrates a flowchart representative of one embodiment of cache-write processing method of write requests in accordance with the present invention;

FIG. 9 illustrates an exemplary execution of the flowchart illustrated in FIG. 8;

FIG. 10 illustrates a flowchart representative of one embodiment of cache-write processing method of read requests in accordance with the present invention; and

FIG. 11 illustrates an exemplary execution of the flowchart illustrated in FIG. 10.

### DETAILED DESCRIPTION OF THE PRESENT INVENTION

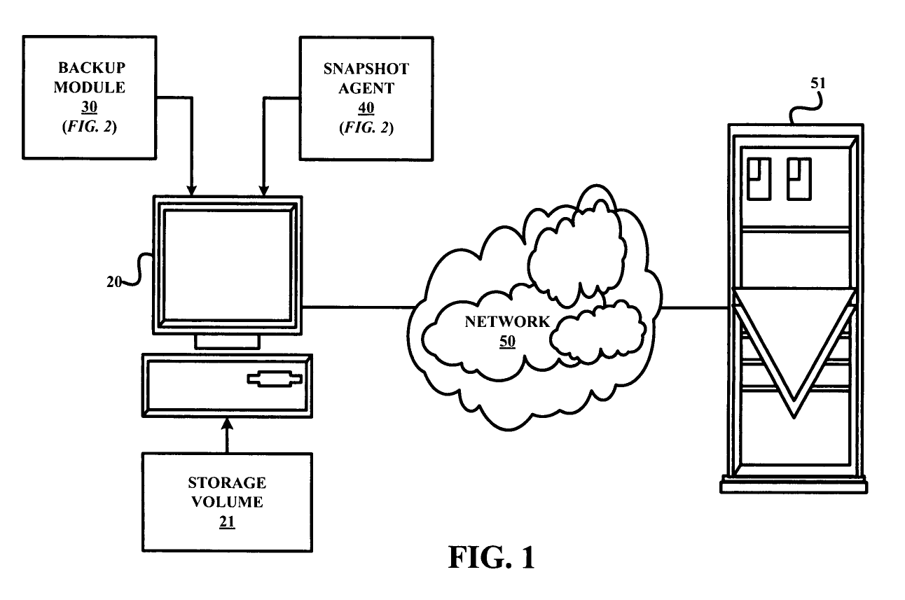

Snapshot operations (e.g., copy-on-write and cache-write) on a file basis of unnecessary files and undesirable files is prevented by the present invention with an integration of a backup module 30 and a snapshot agent 40, both of which are installable on a conventional client 20 as illustrated in FIG. 1. Generally, module 30 and agent 40 facilitate a backup of files stored within a storage volume 21 of client 20 that creates a point-in-time copy of storage volume 21 by snapshot agent 40 on a file basis excluding any unnecessary files and any undesirable files as designated by an operating system of client 20, as designated by a user/administrator of client 20, and/or as internally derived by client 20. The point-in-time copy of storage volume 21 can thereafter be backed Lip by backup module 30 within a virtual file system of client 20, which can be saved on a conventional file server 51 via a network 50 to facilitate a subsequent restore, if necessary, of the data corresponding to the point-in-time copy of storage volume 21 within client 20.

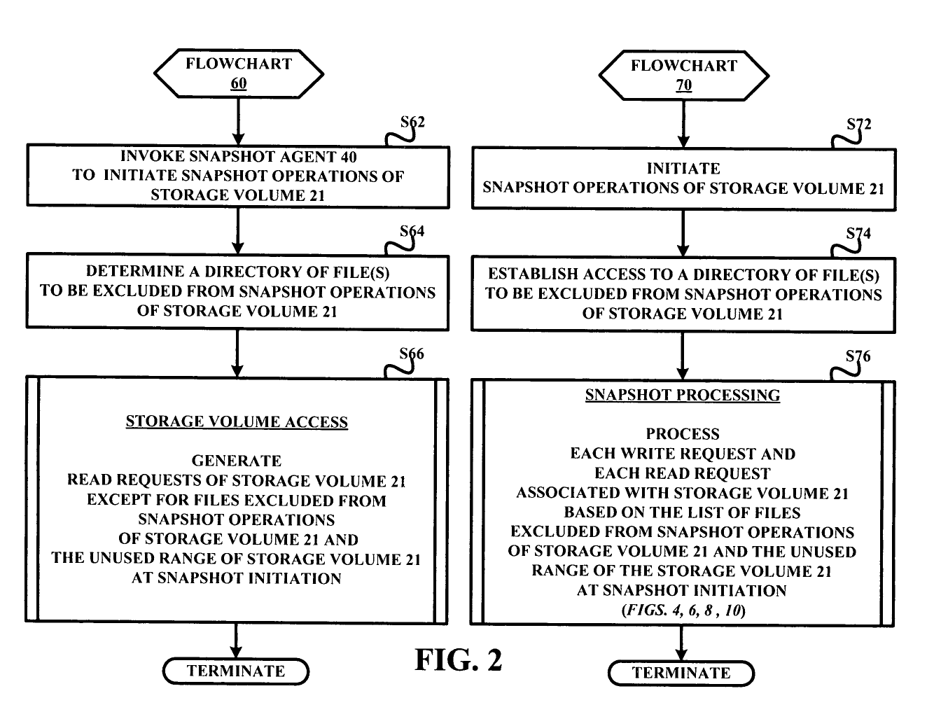

Specifically, as illustrated in FIG. 2, module 30 implements a flowchart 60 representative of a storage volume access method of the present invention and agent 40 implements a flowchart 70 representative of a snapshot processing method of the present invention. The implementation of flowcharts 60 and 70 by module 30 and agent 40, respectively, is accomplished in an integrated manner to ensure that unnecessary files and undesirable files are not backed up by module 30 and processed by agent 40.

Referring to FIGS. 1 and 2, a stage S62 of flowchart 60 encompasses module 30 invoking agent 40 to initiate snapshot operations of storage volume 21, and a stage S72 of flowchart 70 encompasses snapshot agent 40 initiating snapshot operations of storage volume 21 upon being invoked by backup module 30 to thereby establish a point-in-time version of storage volume 21 for the integrated backup/snapshot operations of storage volume 21.

In one embodiment of stage S72, snapshot agent 40 initiates copy-on-write operations of storage volume 21 involving snapshot agent 40 establishing a cache within the memory of client 20, and snapshot agent 40 serving as an access interface of storage volume 21 and the cache to facilitate copy-on-write operations of each update to storage volume 21 involving storage volume 21 and the cache during a stage S76 of flowchart 70 to thereby maintain a point-in-time copy of storage volume 21 for the backup operation of storage volume 21 as would be appreciated by those having ordinary skill in the art. Additionally, upon serving as the access interface of storage volume 21 and the cache, snapshot agent 40 can deny or queue each write request and each read request of storage volume 21 received by snapshot agent 40 until snapshot agent 40 proceeds to stage S76.

In a second embodiment of stage S72, snapshot agent 40 initiates cache-write operations of storage volume 21 involving snapshot agent 40 establishing a cache within the memory of client 20, and snapshot agent 40 serving as an access interface of storage volume 21 and the cache to facilitate cache-write operations of each update to storage volume 21 involving the cache during stage S76 to thereby maintain a point-in-time copy of storage volume 21 for the backup operation of storage volume 21 as would be appreciated by those having ordinary skill in the art. Additionally, upon serving as the access interface of storage volume 21 and the cache, snapshot agent 40 can deny or queue each write request and each read request of storage volume 21 received by snapshot agent 40 until snapshot agent 40 proceeds to stage S76.

Those having ordinary skill in the art will also appreciate other snapshot operations applicable to the present invention.

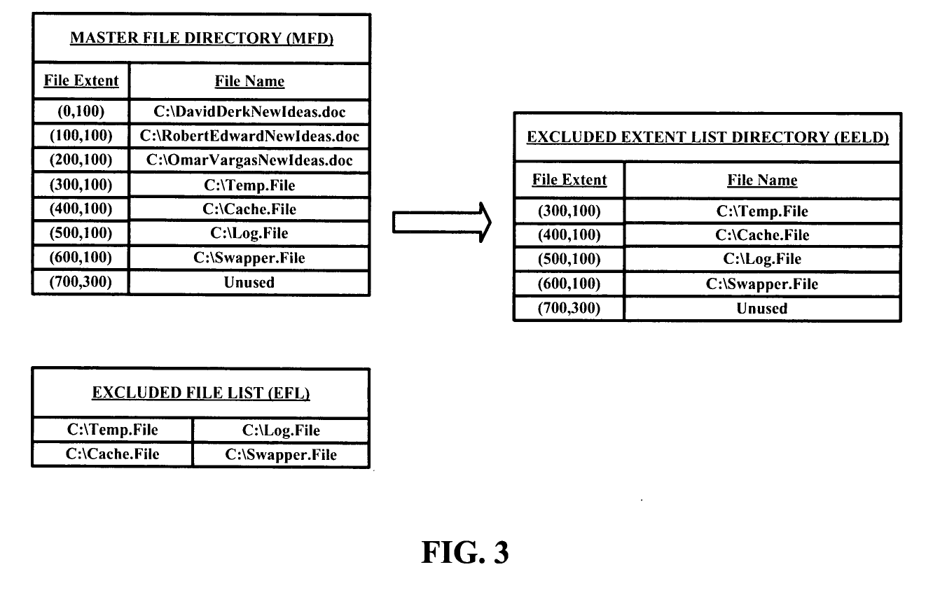

Still referring to FIGS. 1 and 2, a stage S64 of flowchart 60 encompasses backup module 30 determining a directory of files to be excluded from the snapshot operations of storage volume 21 (e.g., snapshot copy-on-write operations or snapshot cache-write operations), and stage S74 of flowchart 70 further encompasses snapshot agent 40 establishing access to the directory of files to be excluded from the snapshot operations of storage volume 21. In practice, the manner by which module 30 implements stage S64 and agent 40 implements stage S74 is without limit. Therefore, the following description of an excluded extent list directory EELD as illustrated in FIG. 3 is not a limitation as to the scope of stage S64 and S74.

Referring to FIGS. 1 and 3, an exemplary master file directory MFD as provided by a file system of client 20 at the time snapshot agent 40 is involved to initiate snapshot operations of storage volume 21, and an exemplary excluded file list EFL as provided by backup module 30 are shown. Master file directory MFD as shown lists seven (7) used file extents of storage volume 21 and their corresponding file names as well as an unused file extent of storage volume 21. Excluded file list EFL includes unnecessary files and undesirable files for backup as designated by an operating system of client 20, as designated by a user/administrator of client 20, and/or as internally derived by client 20.

Backup module 30 applies the excluded file list EFL during stage S64 to master file directory MFD to thereby yield an excluded extent list directory EELD as shown.

The excluded extent list directory EELD lists each file extent and corresponding file name from master file directory MFD that is to be excluded from the snapshot operations of storage volume 21 including the files listed in the excluded file list EFL as well as the unused range of storage volume 21 at a time snapshot operations of storage volume 21 were initiated by agent module 40. Backup module 30 provides the excluded extent list directory EELD to snapshot agent 40 during stage S74.

Referring again to FIGS. 1 and 2, upon a completion of stages S64 and S74, backup module 30 proceeds to a stage S66 of flowchart 60 to access storage volume 21 for purposes of backing up the point-in-time copy of storage volume 21 by generating read requests of storage volume 21 except for the files excluded from the snapshot operations of storage volume 21 and the unused range of storage volume 21 (e.g., the file extents listed in excluded extent list directory EELD shown in FIG. 3). Concurrently, snapshot agent 40 proceeds to a stage S76 of flowchart 70 to process each write request and each read request associated with storage volume 21 received during stages S72-S76 based on the files excluded from the snapshot operations of storage volume 21 and the unused range of storage volume 21 (e.g., the file extents listed in excluded extent list directory EELD shown in FIG. 3).

Flowchart 60 is terminated by module 30 and flowchart 70 is terminated by agent 40 upon module 30 completing a backup of the point-in-time copy of storage volume 21 (i.e., all read requests necessary for module 30 to backup the point-in-time copy of storage volume 21 have been processed by agent 40).

In practice, the manner by which module 30 and agent 40 implement stages S66 and S76, respectively, are without limit. Therefore, the following description of exemplary embodiment of stage S76 in accordance with the present invention is not a limitation as to the scope of stage S76.

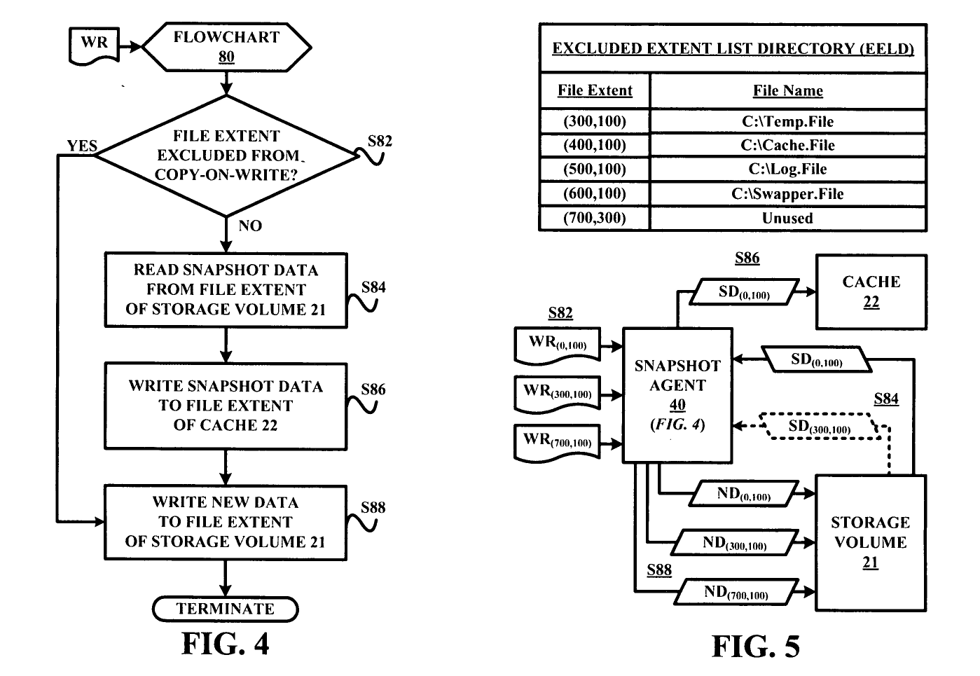

FIG. 4 illustrates a flowchart 80 as one embodiment of stage S76 (FIG. 2) for implementing snapshot copy-on-write operations of write requests of storage volume 21 received by agent 40 during the integrated backup/snapshot operation of storage volume 21. Each write request is directed to a writing of new data to a particular file extent of storage volume 21.

Referring to FIGS. 1 and 4, a stage S82 of flowchart 80 is initiated by a write request WR associated with a file of storage volume 21 where snapshot agent 40 determines whether the file extent corresponding to file of the write request WR is excluded from a copy-on-write of the file. In one embodiment, snapshot agent 40 references an excluded extent list directory of the present invention in determining whether the file extent corresponding to file is excluded from a copy-on-write of the file.

If the file extent is to be excluded from a copy-on-write of the file, snapshot agent 40 proceeds to a stage S88 of flowchart 80 to write the new data associated with the file of write request WR to a file extent of the file in storage volume 21. Otherwise, prior to proceeding to stage S88, snapshot agent 40 sequentially proceeds to a stage S84 and a stage S86 of flowchart 80 to read the snapshot data stored in storage volume 21 and to write the snapshot data to a cache 22 of client 20, respectively. For purposes of the present invention, snapshot data of storage volume 21 is defined as the data within storage volume 21 at the point-in-time of the launching of snapshot agent 40.

FIG. 5 illustrates three (3) examples of an implementation of flowchart 80 by snapshot agent 40.

Referring to FIG. 5, the first example involves a write request WR_{(0,100)} of a file extent (0,100) that is not listed on the excluded extent list directory EELD as shown. As such, file extent (0,100) is not excluded from a copy-on-write of file extent (0,100). Thus, snapshot agent 40 processes write request WR_{(0,100)} by sequentially (1) reading the snapshot data SD_{(0,100)} of file extent (0,100) from storage volume 21, (2) writing snapshot data SD_{(0,100)} to cache 22, and (3) writing the new data ND_{(0,100)} of file extent (0, 100) to storage volume 21.

The second example involves a write request WR_{(300,100)} of a file extent (300,100) that is on the excluded extent list directory EELD as shown. As such, file extent (300,100) is excluded from a copy-on-write of file extent (300,100). Thus, snapshot agent 40 processes write request W_{(300,100)} by writing the new data ND_{(300,100)} of file extent (300,100) to storage volume 21. Prior to the present invention, a copy-on-write of file extent (300, 100) would have been executed under these circumstances. A reading of snapshot data SD_{(300,100)} of file extent (300,100) from storage volume 21 is shown with a dashed outline to signify that a copy-on-write of file extent (300,100) was not performed in accordance with the excluded extent list directory EELD of the present invention.

The third example involves a write request W_{(700,100)} of a file extent (700,100) that is on the excluded extent list directory EELD as shown. As such, file extent (700,100) is excluded from a copy-on-write of file extent (700,100). Thus, snapshot agent 40 processes write request WR_{(700,100)} by writing the new data ND_{(700,100)} of file extent (700,100) to storage volume 21.

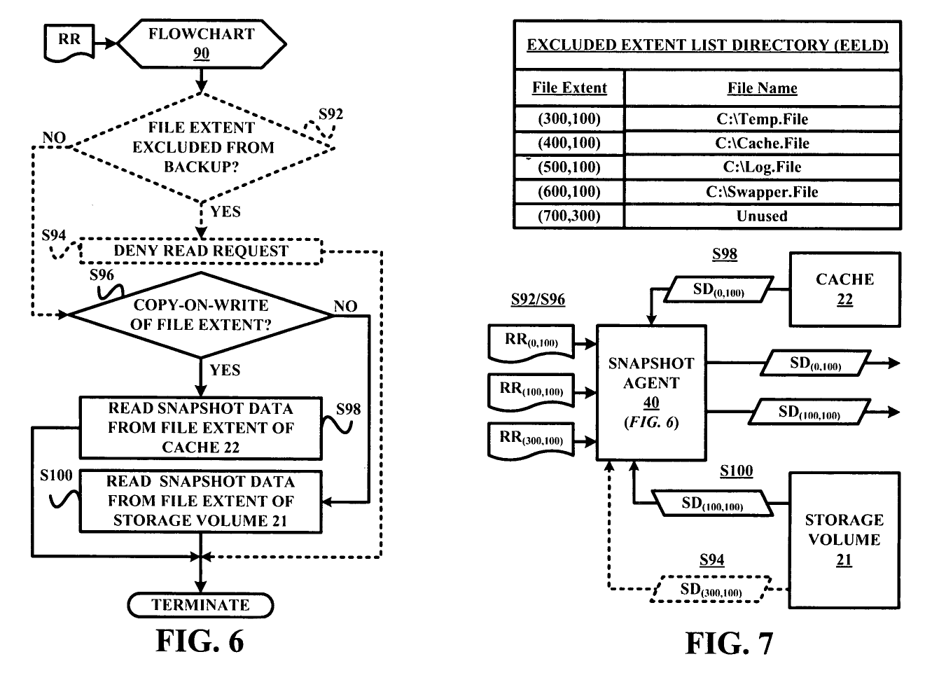

FIG. 6 illustrates a flowchart 90 as one embodiment of stage S76 (FIG. 2) for implementing snapshot copy-on-write operations of read requests of storage volume 21 received by agent 40 during the integrated backup/snapshot operation of storage volume 21. Each read request is directed to a reading of data from a particular file extent of storage volume 21.

Referring to FIGS. 1 and 6, a stage S92 of flowchart 90 is initiated by a read request RR associated with a file of storage volume 21 where snapshot agent 40 determines whether the file extent corresponding to file of the read request RR is excluded from a backup operation of storage volume 21. In one embodiment, snapshot agent 40 references an excluded extent list directory of the present invention in determining whether the file extent corresponding to file is excluded from the backup operation of storage volume 21. If the file extent is excluded from the backup operation of storage volume 21, then snapshot agent 40 proceeds to a stage S94 of flowchart 90 to deny the read request RR. Please note that stage S92 and stage S94 are dashed to signify the fact that stages S92 and S94 are optional in view of the fact that backup module 30 should not generate any read requests for files in storage volume 21 that are excluded from the backup operation of the storage volume 21 in accordance with stage S66 (FIG. 2). Nonetheless, stages S92 and S94 are provided herein to address an erroneous generation by backup module 30 of read requests for files in storage volume 21 that are excluded from the backup operation of the storage volume 21.

Returning to FIGS. 1 and 6, if the file extent is not excluded from the backup operation of storage volume 21, then agent 40 proceeds to a stage S96 of flowchart 90 to determine if a copy-on-write of the file extent has previously occurred for the file of the read request RR. If so, then snapshot agent 40 proceeds to a stage S98 to read the snapshot data of the file extent from cache 22. Otherwise, snapshot agent 40 proceeds to a stage S100 to read the snapshot data of the file extent from storage volume 21.

FIG. 7 illustrates three (3) examples of an implementation of flowchart 100 by snapshot agent 40.

Referring to FIG. 7, the first example involves a read request RR_{(0,100)} from backup module 30 of a file extent (0,100) that is not listed on the excluded extent list directory EELD as shown, but was previously involved in a snapshot copy-on-write operation (FIG. 5). Thus, snapshot agent 40 processes read request RR_{(0,100)} by reading snapshot data SD_{(0,100)} from cache 22 and send snapshot data SD_{(0,100)} to backup module 30.

The second example involves a read request RR_{(100,100)} from backup module 30 of a file extent (100,100) that is not listed on the excluded extent list directory EELD as shown and was not previously involved in a snapshot copy-on-write operation. Thus, snapshot agent 40 processes read request RR_{(100,100)} by reading snapshot data SD_{(100,100)} from storage volume 21 and send snapshot data SD_{(100,100)} to backup module 30.

The last example involves a read request RR_{(300,100)} from backup module 30 of a file extent (300,100) that is listed on the excluded extent list directory EELD as shown. Thus, snapshot agent 40 processes read request RR_{(300,100)} by denying read request RR_{(300,100)} as signified by the dashed outline of snapshot data SD_{(300,100)}.

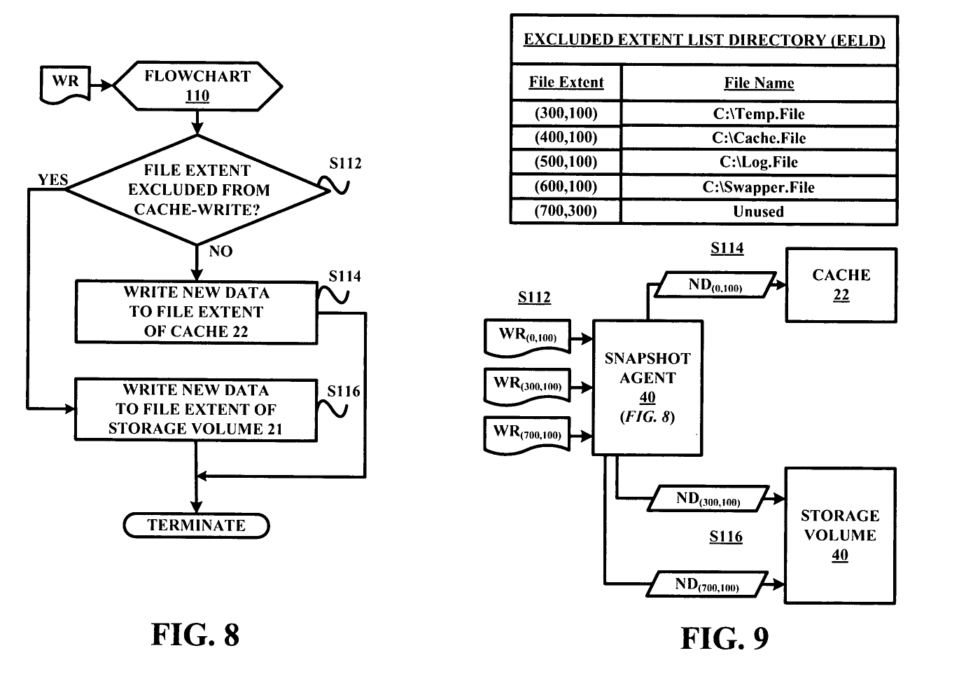

FIG. 8 illustrates a flowchart 110 as one embodiment of stage S76 (FIG. 2) for implementing a snapshot cache-write operations of write requests of storage volume 21 received by agent 40 during the integrated backup/snapshot operation of storage volume 21. Each write request is directed to a writing of new data to a particular file extent of storage volume 21.

Referring to FIGS. 1 and 8, a stage S112 of flowchart 110 is initiated by a write request WR associated with a file of storage volume 21 where snapshot agent 40 determines whether the file extent corresponding to file of the write request WR is excluded from a cache-write of the file. In one embodiment, snapshot agent 40 references an excluded extent list directory of the present invention in determining whether the file extent corresponding to file is excluded from a cache-write of the file. If the file extent is to be excluded from a cache-write of the file, then snapshot agent 40 proceeds to a stage S116 of flowchart 110 to write the new data associated with the file of write request WR to storage volume 21. Otherwise, snapshot agent 40 proceeds to a stage S114 of flowchart 110 write the new data associated with the file of write request WR to cache 22.

FIG. 9 illustrates three (3) examples of an implementation of flowchart 110 by snapshot agent 40.

Referring to FIG. 9, the first example involves a write request WR_{(0,100)} of a file extent (0,100) that is not listed on the excluded extent list directory EELD as shown. As such, file extent (0,100) is not excluded from a cache-write of file extent (0,100). Thus, snapshot agent 40 processes write request WR_{(0,100)} by sequentially writing new data ND_{(0,100)} to cache 22.

The second example involves a write request WR_{(300,100)} of a file extent (300,100) that is listed on the excluded extent list directory EELD as shown. As such, file extent (300,100) is excluded from a cache-write of file extent (300,100). Thus, snapshot agent 40 processes write request WR_{(300,100)} by sequentially writing new data ND_{(300,100)} to storage volume 21.

The last example involves a write request WR_{(700,100)} of a file extent (700,100) that is listed on the excluded extent list directory EELD as shown. As such, file extent (700,100) is excluded from a cache-write of file extent (700,100). Thus, snapshot agent 40 processes write request WR_{(700,100)} by sequentially writing new data ND_{(700,100)} to storage volume 21.

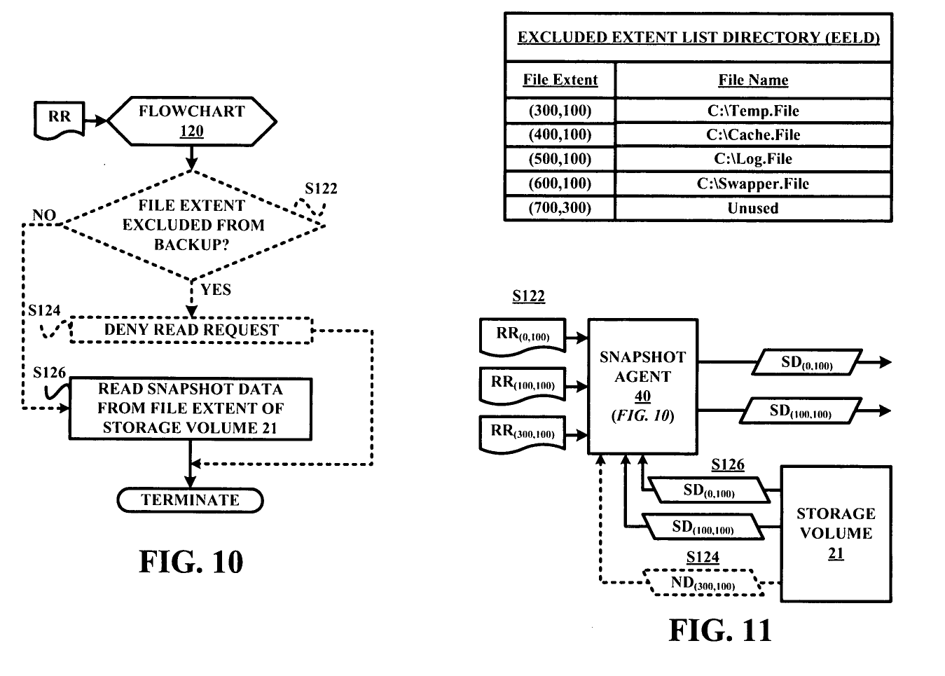

FIG. 10 illustrates a flowchart 120 as one embodiment of stage S76 (FIG. 2) for implementing snapshot cache-write operations of read requests of storage volume 21 received by agent 40 during the integrated backup/snapshot operation of storage volume 21. Each read request is directed to a reading of data from a particular file extent of storage volume 21.

Referring to FIGS. 1 and 10, a stage S122 of flowchart 120 is initiated by a read request RR associated with a file of storage volume 21 where snapshot agent 40 determines whether the file extent corresponding to file of the read request RR is excluded from the backup operation of storage volume 21. In one embodiment, snapshot agent 40 references an excluded extent list directory of the present invention in determining whether the file extent corresponding to file is excluded from the backup operation of storage volume 21. If the file extent is excluded from the backup operation of storage volume 21, then snapshot agent 40 proceeds to a stage S124 of flowchart 120 to deny the read request RR. Please note that stage S122 and stage S124 are dashed to signify the fact that stages S122 and S124 are optional in view of the fact that backup module 30 should not generate any read requests for files in storage volume 21 that are excluded from the backup operation of the storage volume 21 in accordance with stage S66 (FIG. 2). Nonetheless, stages S122 and S124 are provided herein to address an erroneous generation by backup module 30 of read requests for files in storage volume 21 that are excluded from the backup operation of the storage volume 21.

Returning to FIGS. 1 and 10, if the file extent is not excluded from the backup operation of storage volume 21, then agent 40 proceeds to a stage S126 of flowchart 120 to read the snapshot data of the file extent from storage volume 21.

FIG. 11 illustrates three (3) examples of an implementation of flowchart 120 by snapshot agent 40.

Referring to FIG. 11, the first example involves a read request RR_{(0,100)} from backup module 30 of a file extent (0,100) that is not listed on the excluded extent list directory EELD as shown, but was previously involved in a snapshot cache-write operation (FIG. 9). Thus, snapshot agent 40 processes read request RR_{(0,100)} by reading snapshot data SD_{(0,100)} from storage volume 21 and sending snapshot data SD_{(0,100)} to backup module 30.

The second example involves a read request RR_{(100,100)} from backup module 30 of a file extent (100,100) that is not listed on the excluded extent list directory EELD as shown and was not previously involved in a snapshot cache-write operation. Thus, snapshot agent 40 processes read request RR_{(100,100)} by reading snapshot data SD_{(100,100)} from storage volume 21 and sending snapshot data SD_{(100,100)} to backup module 30.

The last example involves a read request RR_{(300,100)} from backup module 30 of a file extent (300,100) that is listed on the excluded extent list directory EELD and was previously involved in a snapshot cache-write operation (FIG. 9). Thus, snapshot agent 40 processes read request RR_{(300,100)} by denying a read of new data ND_{(300,100)} as signified by the dashed outline of new data ND_{(300,100)}.

From the preceding description of FIGS. 1-11, those having ordinary skill in the art will appreciate numerous advantages of the present invention. Foremost among such advantages is an elimination of unnecessary and undesirable snapshot operations during an integrated backup/snapshot operation of a storage volume, and a minimal size of the cache established during the integrated backup/snapshot operation of a storage volume.

Furthermore, those having ordinary skill in the art will appreciate an integration of the snapshot operation of storage volume 21 in accordance with the present invention as shown in FIG. 2 with operations other than a backup operation of storage volume 21, such as, for example, database testing or any application used for testing, training or problem analysis.

Referring to FIG. 1, in one practical embodiment, module 30 and agent 40 are embodied in a software module integrated with a commercially available software application entitled “IBM Tivoli Storage Manager”. As such, module 30 and agent 40 are installed along within a memory of a client 20 or distributed among various client memories whereby the client processor(s) can execute module 30 and agent 40 to perform various operations of the present invention as exemplary illustrated in FIGS. 1-11. Module 30 and agent 40 when embodied as a software module can be written in any conventional programming language by those having ordinary skill in the art appreciating the description herein of FIGS. 1-11 (e.g., C++ language).

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A signal bearing medium tangibly embodying a program of machine-readable instructions executable by at least one processor to perform operations comprising:
initiating snapshot operations of a storage volume;
establishing access to a directory of at least one file to be excluded from the snapshot operations of the storage volume; and
processing a write request associated with the storage volume based on the directory of at least one file to be excluded from the snapshot operations of the storage volume.

2. The signal bearing medium of claim 1, wherein the directory is derived from a master file directory associated with the storage volume at a time snapshot operations of the storage volume were initiated and an excluded file list associated with the snapshot operations of the storage volume.

3. The signal bearing medium of claim 1, wherein the directory lists a file extent of each file of at least one file to be excluded from the snapshot operations of the storage volume.

4. The signal bearing medium of claim 3, wherein the directory further lists a file extent of each unused range of the storage volume at a time snapshot operations of the storage volume were initiated.

5. The signal bearing medium of claim 1, wherein the snapshot operations include copy-on-write operations.

6. The signal bearing medium of claim 5, wherein processing the write request associated with the storage volume based on the directory of at least one file to be excluded from the snapshot operations of the storage volume includes:
writing new data associated with the write request to a corresponding file extent of the storage volume in response to the file extent being listed in the directory.

7. The signal bearing medium of claim 5, wherein processing the write request associated with the storage volume based on the directory of at least one file to be excluded from the snapshot operation of the storage volume includes:
reading snapshot data from a file extent of the storage volume corresponding with the write request in response to the file extent not being listed in the directory, subsequently writing the snapshot data as read from the storage volume to a corresponding file extent of a cache and writing the new data associated with the write request to the file extent of the storage volume.

8. The signal bearing medium of claim 1, wherein the snapshot operations include cache-write operations.

9. The signal bearing medium of claim 8, wherein processing the write request associated with the storage volume based on the directory of at least one file to be excluded from the snapshot operations of the storage volume includes:
writing new data associated with the write request to a corresponding file extent of the storage volume in response to the file extent being listed in the directory.

10. The signal bearing medium of claim 8, wherein processing the write request associated with the storage volume based on the directory of at least one file to be excluded from the snapshot operations of the storage volume includes:
writing new data associated with the write request to a corresponding file extent of the cache in response to the file extent not being listed in the directory.

11. A system, comprising:
at least one processor; and
at least one memory storing instructions operable with the at least one processor, the instructions being executed for:
initiating snapshot operations of a storage volume;
establishing access to a directory of at least one file to be excluded from the snapshot operations of the storage volume; and
processing a write request associated with the storage volume based on the directory of at least one file to be excluded from the snapshot operations of the storage volume.

12. The system of claim 11, wherein the directory is derived from a master file directory associated with the storage volume at a time snapshot operations of the storage volume were initiated and an excluded file list associated with the snapshot operations of the storage volume.

13. The system of claim 11, wherein the directory lists a file extent of each file of at least one file to be excluded from the snapshot operations of the storage volume.

14. The system of claim 13, wherein the directory further lists a file extent of each unused range of the storage volume at a time snapshot operations of the storage volume were initiated.

15. The system of claim 11, wherein the snapshot operations include copy-on-write operations.

16. The system of claim 15, wherein processing the write request associated with the storage volume based on the directory of at least one file to be excluded from the snapshot operations of the storage volume includes:
writing new data associated with the write request to a corresponding file extent of the storage volume in response to the file extent being listed in the directory.

17. The system of claim 15, wherein processing the write request associated with the storage volume based on the directory of at least one file to be excluded from the snapshot operation of the storage volume includes:
reading snapshot data from a file extent of the storage volume corresponding with the write request in response to the file extent not being listed in the directory, subsequently writing the snapshot data as read from the storage volume to a corresponding file extent of a cache and writing the new data associated with the write request to the file extent of the storage volume.

18. The system of claim 11, wherein the snapshot operations include cache-write operations.

19. The system of claim 18, wherein processing the write request associated with the storage volume based on the directory of at least one file to be excluded from the snapshot operations of the storage volume includes:
writing new data associated with the write request to a corresponding file extent of the storage volume in response to the file extent being listed in the directory.

20. The system of claim 18, wherein processing the write request associated with the storage volume based on the directory of at least one file to be excluded from the snapshot operations of the storage volume includes:
writing new data associated with the write request to a corresponding file extent of the cache in response to the file extent not being listed in the directory.

21. A system, comprising:
means for initiating the snapshot operation of the storage volume;
means for initiating snapshot operations of a storage volume;
means for establishing access to a directory of at least one file to be excluded from the snapshot operations of the storage volume; and
means for processing a write request associated with the storage volume based on the directory of at least one file to be excluded from the snapshot operations of the storage volume.

22. The system of claim 21, wherein the snapshots operation of the storage volume are integrated with backup operations of the storage volume.

23. A client computer, comprising:
a backup module operable to process backup operations of a storage volume; and
a snapshot agent operable to process snapshot operations of the storage volume,
wherein the backup operations of the storage volume and the snapshot operations of the storage volume are integrated based on a directory of at least one file to be excluded from the integrated backup/snapshot operations of the storage volume.

24. A client computer, comprising:
a backup module operable to process backup operations of a storage volume; and
a snapshot agent operable to process snapshot operations of the storage volume,
wherein the backup module and the snapshot agent includes means for integrating the backup operations of the storage volume and the snapshot operations of the storage volume based on a directory of at least one file to be excluded from the integrated backup/snapshot operations of the storage volume.
